(19) United States
(12) Patent Application Publication
(10) Pub. No.: US 2019/0152035 A1
(43) Pub. Date: May 23, 2019

(54) POWDER ACTUATED TOOL

(71) Applicant: Chung-Heng Lee, New Taipei City (TW)

(72) Inventor: Chung-Heng Lee, New Taipei City (TW)

(21) Appl. No.: 15/819,302

(22) Filed: Nov. 21, 2017

(51) Int. Cl. B25C 1/14; B25C 1/18; B25C 1/16; B25C 1/00

(52) U.S. Cl. CPC B25C 1/143; B25C 1/008; B25C 1/163; B25C 1/18

(57) ABSTRACT

A powder actuated tool is used for driving a fastener along a striking path line in a longitudinal direction into a wall surface, and is adapted for loading therein a cartridge strip. The powder actuated tool has a smaller width than a length between a leading edge of a first loading one of cartridges and a trailing end of the cartridge strip.

### FIELD

The disclosure relates to an actuated tool for driving a fastener into a wall surface, more particularly to a powder actuated tool for driving a fastener into a wall surface.

### BACKGROUND

A conventional powder actuated tool is normally loaded with a cartridge strip having ten cartridges, and is used for driving a fastener into a hard surface, such as ceilings of concrete etc., so as to secure for example a light steel frame structure on the hard surface. The conventional powder actuated tool includes a magazine channel extending in a direction transverse to a lengthwise direction of the powder actuated tool, and thus rendering the tool structure wide and bulky. For example, when remodeling the old buildings, like making fastenings on a ceiling with a plurality of existing pipes, wires, or decorations, access of the conventional powder actuated tool to predetermined positions on the ceiling may be blocked by the said existing pipes, wires, or decorations. In addition, the operation of the conventional powder actuated tool is noisy.

### SUMMARY

Therefore, an object of the disclosure is to provide a novel powder actuated tool for loading therein a cartridge strip, which has a reduced width compared to the above conventional powder actuated tool, and which may be equipped with a sound suppressor for reducing amount of noise when operating while maintaining the reduced width of the tool without further adding size of the tool.

According to a first aspect of the disclosure, a compression triggered powder actuated tool is used for driving a fastener along a striking path line in a longitudinal direction into a wall surface. The powder actuated tool is adapted for loading therein a cartridge strip which includes a plurality of cartridges displaced from one another along a strip line, and a connection strip that is configured to hold the cartridges, and that extends along the strip line to terminate at a leading end and a trailing end. The powder actuated tool includes a tubular housing, a side frame, a piston unit, a firing pin, and an actuating unit. The tubular housing is hollow inside, and extends along the striking path line to terminate at an upper open end and a lower open end. The tubular housing has an inlet port and an outlet port which is opposite to the inlet port in a first direction transverse to the longitudinal direction to permit passage of the cartridge strip therethrough. The side frame is mounted to the tubular housing, and defines therein a feeding channel for loading therein the cartridge strip. The feeding channel includes a feed-in port proximate to the upper open end, a longitudinal zone disposed downstream of the feed-in port and extending in the longitudinal direction, a transverse zone disposed downstream of the longitudinal zone and upstream of the inlet port and extending in the first direction, a transition zone interconnecting the longitudinal zone and the transverse zone, such that the powder actuated tool has a maximum width in a direction normal to the longitudinal direction which is smaller than a length from a leading edge of a first loading one of the cartridges to the trailing end. The piston unit is slidably mounted within the tubular housing, and is configured to strike the fastener along the striking path line. The firing pin is configured to be slidably disposed within the tubular housing, and is disposed beneath the piston unit. The firing pin is coupled for igniting one of the loaded cartridges inside the tubular housing so as to generate propellant gases to thereby force the piston unit to strike the fastener. The actuating unit is disposed in or in proximity to the lower open end, and is configured to permit one of the loaded cartridges inside the tubular housing to be ignited in response to axial movement of the actuating unit in the longitudinal direction.

According to a second aspect of the disclosure, a compression triggered powder actuated tool is used for driving a fastener along a striking path line in a longitudinal direction into a wall surface, and is adapted for loading therein a cartridge strip which includes a plurality of cartridges displaced from one another in a strip line, and a connection strip that is non-stretchable along the strip line, and that is configured to hold the cartridges. The connection strip has a plurality of releasable retained members which alternate with the cartridges. The powder actuated tool includes a tubular housing, a barrel, a first biasing member, a nosepiece, a piston, a piston rod, a side frame, a firing pin, a third biasing member, and an actuating rod. The tubular housing extends along the striking path line, and includes an upper tubular segment, a lower tubular segment, and an intermediate tubular segment. The upper tubular segment defines therein an upper space, and has an upper open end. The lower tubular segment defines therein a lower space, and having a lower open end opposite to the upper open end. The intermediate tubular segment is disposed between the upper and lower tubular segments, and defines therein a firing chamber which interconnects the upper and lower spaces, and which includes an inlet port and an outlet port that are opposite to each other in a first direction transverse to the longitudinal direction to permit passage of the cartridge strip therethrough thereby introducing one of the loaded cartridges in the firing chamber. The barrel is fitted slidably in the upper space, and has an upper coupling end and a lower breech end. The barrel defines therein a barrel bore which extends along the striking path line and which has a lower bore region proximate to the lower breech end. The barrel is movable in the longitudinal direction between a loading position, where the lower breech end is disposed above the firing chamber, and a ready-to-fire position, where the lower breech end is disposed in the firing chamber to receive the one of the loaded cartridges at a priming position. The first biasing member is disposed to bias the barrel to the loading position. The nosepiece is coupled to the upper coupling end of the barrel to permit the barrel to move therewith, and is capable of making a retraction movement when pressed against the wall surface to thereby force the barrel to move to the ready-to-fire position against a biasing force of the first biasing member. The nosepiece has a muzzle bore which is configured to hold the fastener in the striking path line. The piston is slidably mounted within the barrel bore, and is configured to be fitted in the lower bore region to seal the firing chamber when the barrel is in the ready-to-fire position. The piston rod extends upwardly from the piston along the striking path line into the muzzle bore to terminate at a rod end which is configured to strike the fastener along the striking path line. The side frame is mounted to the upper tubular segment, and defines therein a feeding channel for loading therein the cartridge strip. The feeding channel includes a feed-in port, a longitudinal zone, a transverse zone, and a transition zone. The feed-in port is proximate to the upper open end. The longitudinal zone is disposed downstream of the feed-in port, and extends in the longitudinal direction. The transverse zone is disposed downstream of the longitudinal zone and upstream of the inlet port, and extends in the first direction. The transition zone interconnects the longitudinal zone and the transverse zone. The firing pin is configured to be slidably disposed within the lower space, and extends in the longitudinal direction to terminate at a firing pin tip and a butt end. The firing pin is movable in the longitudinal direction between a downward position, where the firing pin tip is spaced apart from the firing chamber, and a firing position, where the firing pin tip moves into the firing chamber so as to ignite the one of the loaded cartridges at the priming position to generate propellant gases to thereby force the piston rod to strike the fastener. The third biasing member is disposed to bias the firing pin to the downward position. The actuating rod is coupled to the butt end through the lower open end, and is configured to force the firing pin to move in the longitudinal direction toward the firing position against a biasing force of the third biasing member.

### BRIEF DESCRIPTION OF THE DRAWINGS

Other features and advantages of the disclosure will become apparent in the following detailed description of the embodiment(s) with reference to the accompanying drawings, in which:

FIG. 1 is a perspective view of a powder actuated tool according to an embodiment of the disclosure;

FIG. 2 is an exploded perspective view of the powder actuated tool;

FIG. 3 is similar to FIG. 2 but viewing from an opposite side;

FIG. 4 is a cross-sectional view of the powder actuated tool taken along a longitudinal direction;

FIG. 5 is a fragmentary enlarged view of a cartridge advancing unit in the powder actuated tool;

FIG. 6 is a fragmentary enlarged view of the powder actuated tool with a cartridge strip loaded therein;

FIG. 7 is a fragmentary enlarged perspective view of a transverse zone of a feeding channel in the powder actuated tool;

FIG. 8 is similar to FIG. 5 but illustrating that the cartridge strip is loaded and a claw member is in a yielded state;

FIG. 9 is similar to FIG. 8 but illustrating the claw member in a non-yielded state;

FIG. 10 is a cross-sectional view taken along a plane transverse to the longitudinal direction;

FIG. 11 is similar to FIG. 4 but illustrating that the cartridge strip is loaded and a barrel is in a ready-to-fire position;

FIG. 12 is similar to FIG. 11 but illustrating that after one of loaded cartridges at a priming position is spent, a pressed end segment of a press member is moved to a proximate position to permit a next one of the loaded cartridges to be loaded to the priming position;

FIG. 13 is similar to FIG. 12 but illustrating that the pressed end segment is biased to a distal position.

### DETAILED DESCRIPTION

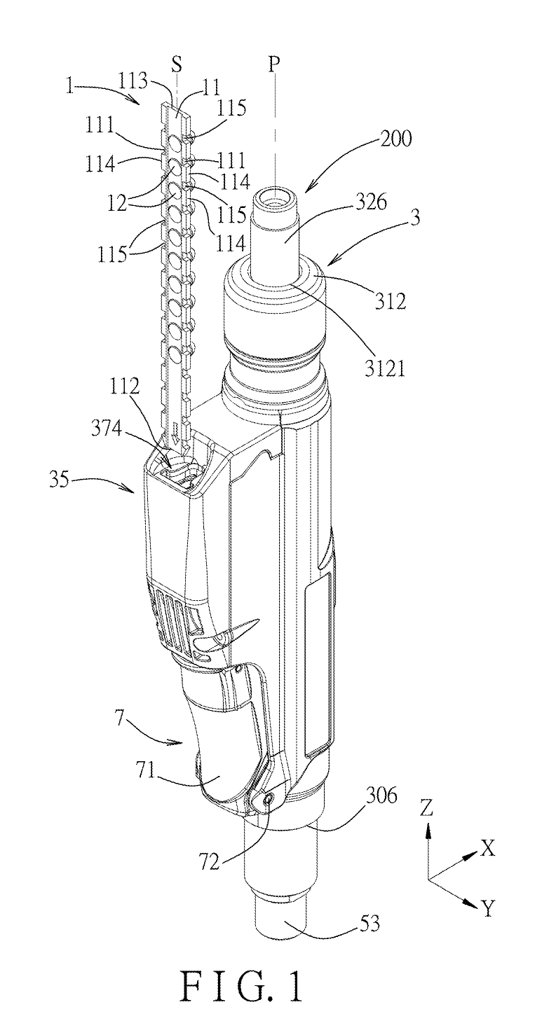

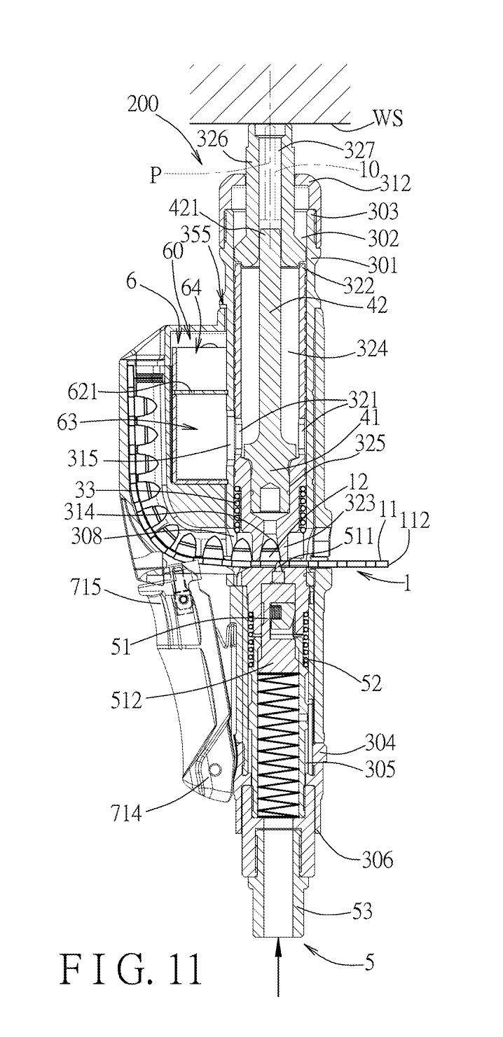

As shown in FIGS. 1 and 11, a compression triggered powder actuated tool 200 according to an embodiment of this disclosure is used for driving a fastener 10 along a striking path line (P) in a longitudinal direction (Z) into a wall surface (WS), and is adapted for loading therein a cartridge strip 1. The cartridge strip 1 includes a plurality of cartridges 12 displaced from one another along a strip line (S), and a connection strip 11 which is non-stretchable along the strip line (S), and which is configured to hold the cartridges 12. The connection strip 11 includes two longitudinal side edges 111, a leading end 112, and a trailing end 113. Each of the longitudinal side edges 111 has a plurality of releasable retained members 115 which alternate with the cartridges 12, and which are displaced from each other by an in-between region 114. Normally, each of the releasable retained members 115 is in the form of a notch, and the cartridge strip 1 includes ten of the cartridges 12.

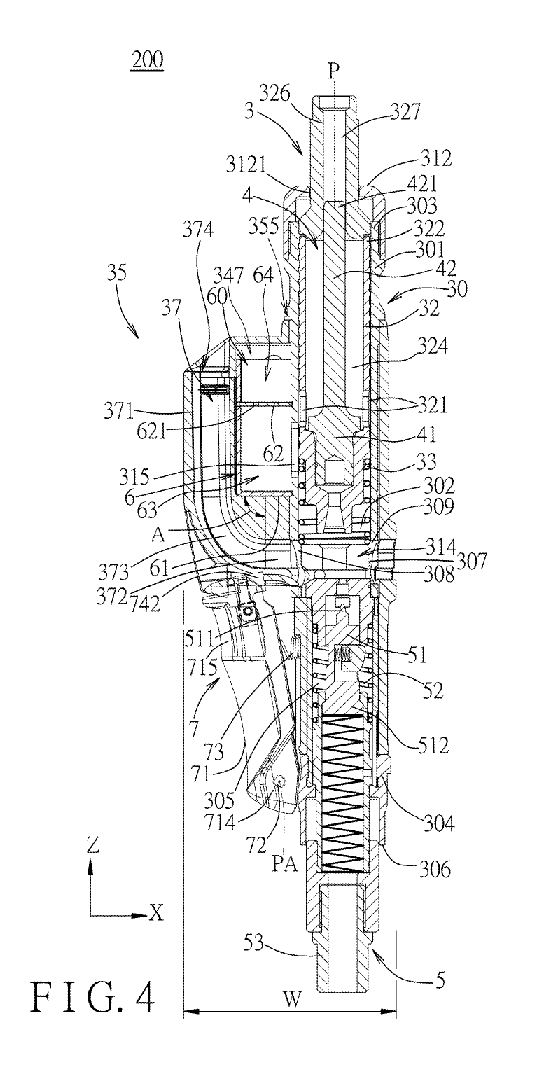

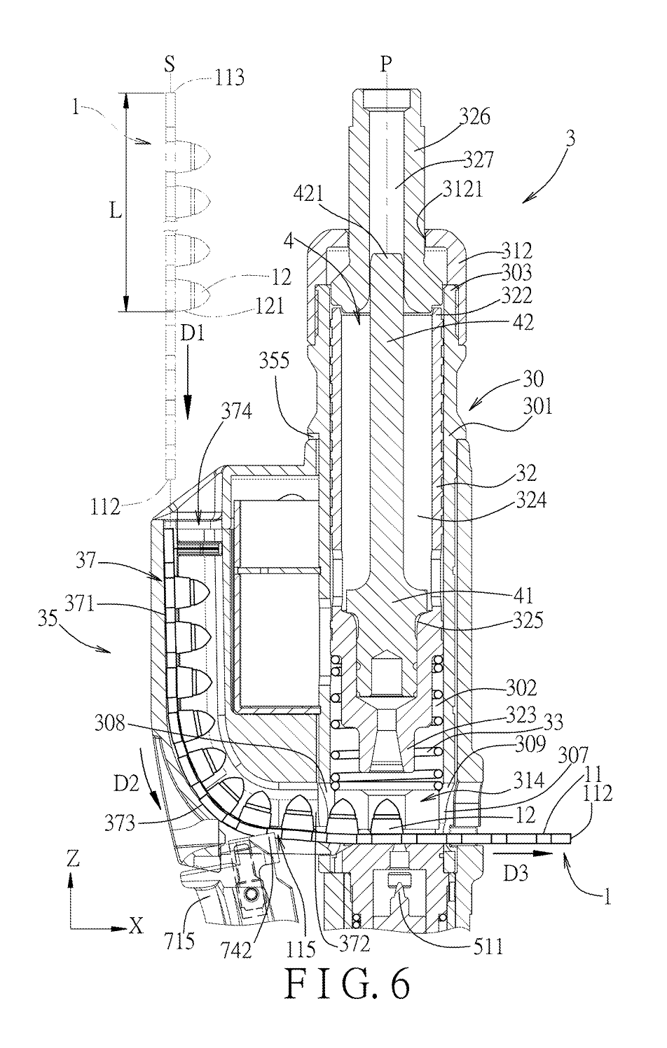

Referring to FIGS. 4 and 6, the impact actuated tool 200 is shown to include a housing unit 3, a first biasing member 33, a piston unit 4, a cartridge advancing unit 7, a firing pin 51, and an actuating unit 5. The housing unit 3 includes a tubular housing 30, a barrel 32, a nosepiece 326, and a side frame 35. The piston unit 4 includes a piston 41 and a piston rod 42. The actuating unit 5 includes a third biasing member 52 and an actuating rod 53.

The tubular housing 30 extends along the striking path line (P), and includes an upper tubular segment 301, a lower tubular segment 304, and an intermediate tubular segment 307.

The upper tubular segment 301 defines therein an upper space 302, and has an upper open end 303. In this embodiment, the upper tubular segment 301 is formed with a first through hole 315.

The lower tubular segment 304 defines therein a lower space 305, and has a lower open end 306 opposite to the upper open end 303.

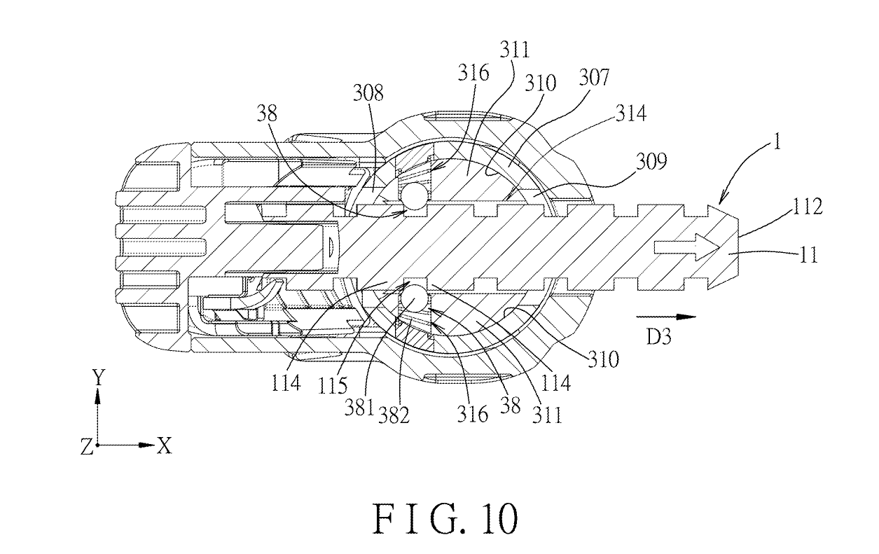

The intermediate tubular segment 307 is disposed between the upper and lower tubular segments 301, 304, and defines therein a firing chamber 314. The firing chamber 314 interconnects the upper and lower spaces 302, 305, and includes an inlet port 308 and an outlet port 309 which are opposite to each other in a first direction (X) transverse to the longitudinal direction (Z) to permit passage of the cartridge strip 1 therethrough thereby introducing one of the loaded cartridges 12 in the firing chamber 314. In this embodiment, as shown in FIG. 10, the intermediate tubular segment 307 has two inner surface regions 310 opposite to each other in a second direction (Y) transverse to both the longitudinal direction (Z) and the first direction (X).

The barrel 32 is fitted slidably in the upper space 302, and has an upper coupling end 322 and a lower breech end 323 (see FIG. 6). The barrel 32 defines therein a barrel bore 324 which extends along the striking path line (P) and which has a lower bore region 325 proximate to the lower breech end 323. The barrel 32 is movable in the longitudinal direction (Z) between a loading position and a ready-to-fire position. When the barrel 32 is in the loading position, as shown in FIGS. 4, 6, 12, and 13, the lower breech end 323 is disposed above the firing chamber 314 to permit loading of the cartridge strip 1 into the firing chamber 314. When the barrel 32 is in the ready-to-fire position, as shown in FIG. 11, the lower breech end 323 is disposed in the firing chamber 314 to receive one of the loaded cartridges 12 at a priming position. In this embodiment, the barrel 32 is formed with a second through hole 321, and is in fluid communication with the first through hole 315 when the barrel 32 is moved to the read-to-fire position.

The first biasing member 33 is disposed in the upper space 302 to bias the barrel 32 to the loading position.

The nosepiece 326 is coupled to the upper coupling end 322 of the barrel 32 to permit the barrel 32 to move therewith, and is capable of making a retraction movement when pressed against the wall surface (WS) to thereby force the barrel 30 to move to the ready-to-fire position against a biasing force of the first biasing member 33 (see FIG. 11). The nosepiece 326 has a muzzle bore 327 which is configured to hold the fastener 10 in the striking path line (P).

In this embodiment, as shown in FIG. 4, the housing unit 3 further includes a cap member 312 which is disposed to enclose the upper open end 303 so as to restrict movement of the barrel 32 between the loading position and the ready-to-fire position, and which has a through bore 3121 configured to permit passing of the nosepiece 326.

As shown in FIGS. 4, 6, and 11, the piston 41 is slidably mounted within the barrel bore 324, and is configured to be fitted in the lower bore region 325 to seal the firing chamber 314 when the barrel 32 is in the ready-to-fire position (FIG. 11).

The piston rod 42 extends upwardly from the piston 41 along the striking path line (P) into the muzzle bore 327 to terminate at a rod end 421 which is configured to strike the fastener 10 along the striking path line (P).

The side frame 35 is mounted to the upper tubular segment 301, and defines therein a feeding channel 37 for loading therein the cartridge strip 1.

As best shown in FIG. 6, the feeding channel 37 includes a feed-in port 374, a longitudinal zone 371, a transverse zone 372, and a transition zone 373. The feed-in port 374 is proximate to the upper open end 303. The longitudinal zone 371 is disposed downstream of the feed-in port 374, and extends in the longitudinal direction (Z). The transverse zone 372 is disposed downstream of the longitudinal zone 371 and upstream of the inlet port 308, and extends in the first direction (X). The transition zone 373 interconnects the longitudinal zone 371 and the transverse zone 372.

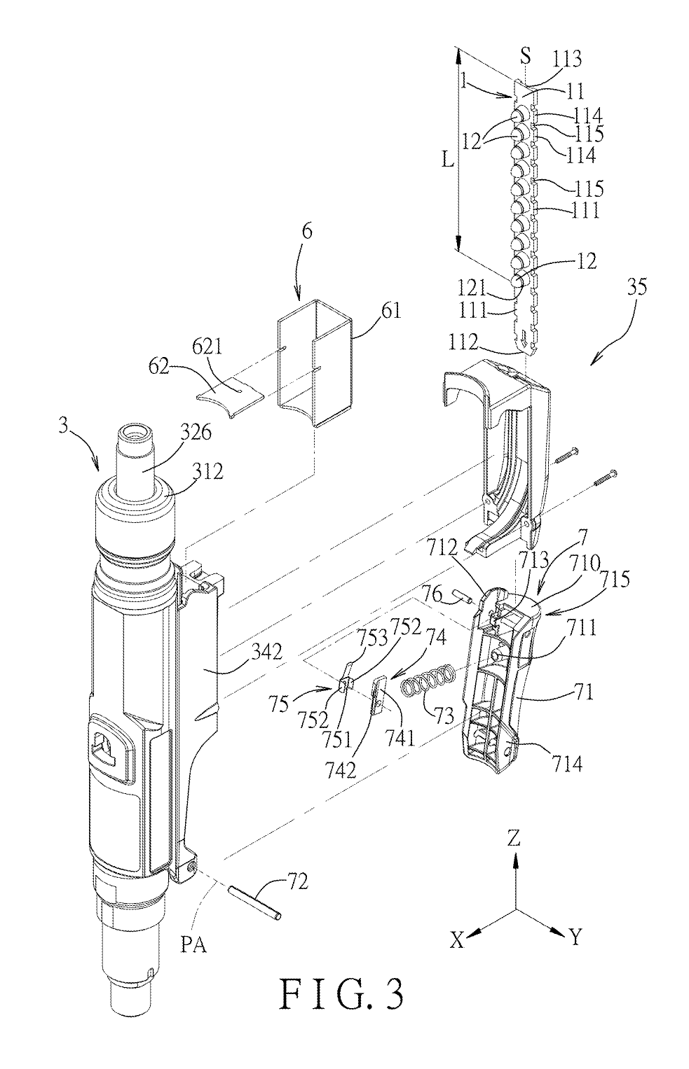

As shown in FIG. 4, because the feed-in port 374, the longitudinal zone 371, the transverse zone 372, and the transition zone 373 of the feeding channel 37 are arranged as above, the powder actuated tool 200 can have a maximum width (W) in a direction normal to the longitudinal direction (Z) which is smaller than a length (L) from a leading edge of a first loading one of the cartridges 12 to the trailing end 113 (see FIGS. 3 and 6). The direction normal to the longitudinal direction (Z) may be the first direction (X), the second direction (Y), or any other directions normal to the longitudinal direction (Z).

In this embodiment, as shown in FIG. 4, an included angle (A) defined between the longitudinal zone 371 and the transverse zone 372 is 90°. In other embodiments, the included angle (A) may range from 90° to 94°.

As shown in FIG. 6, the leading end 112 of the cartridge strip 1 is fed into the longitudinal zone 371 through the feed-in port 374 along an arrow D1 in the longitudinal direction (Z). Next, the leading end 112 is fed to the transition zone 373 to permit the cartridge strip 1 to be guided to move along an arrow D2. Thereafter, the leading end 112 is moved through the transverse zone 372 and the inlet port 308 along an arrow D3 in the first direction (X) to be discharged from the outlet port 309.

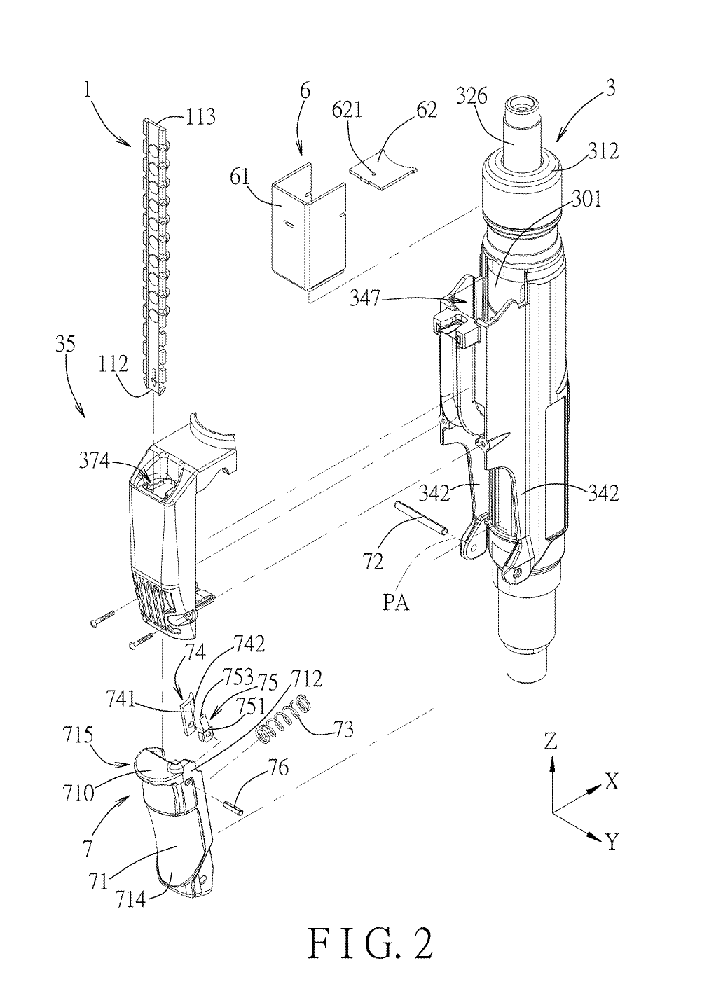

Referring back to FIGS. 2 to 4, it is shown that the cartridge advancing unit 7 includes a press member 71, a second biasing member 73, a claw member 74, and a leaf spring 75.

The press member 71 has a pivot end segment 714 and a pressed end segment 715. The pivot end segment 714 is pivotally mounted relative to the lower tubular segment 304 about a pivot axis (PA) in the second direction (Y). A pivot pin 72 extends along the pivot axis (PA) and has two ends which are mounted respectively to lower ends of two sidewalls 342 mounted on the lower tubular segment 304. The pivot end segment 714 is pivotally mounted to the pivot pin 72 about the pivot axis (PA).

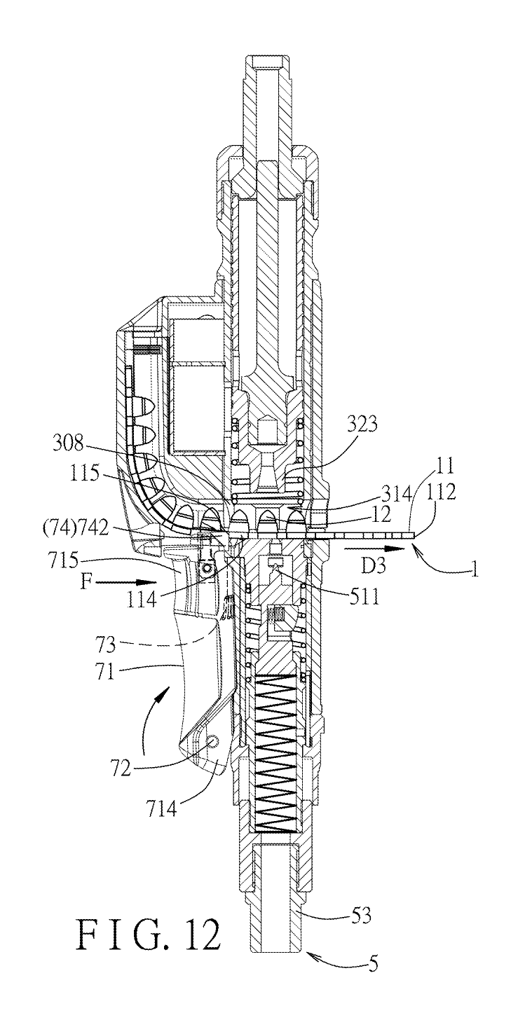

The pressed end segment 715 is opposite to the pivot end segment 714, and is disposed in proximity to the feeding channel 37 (see FIGS. 4 and 6). The pressed end segment 715 is angularly movable about the pivot axis (PA) between a distal position (FIGS. 4, 11, and 13) and a proximate position (FIG. 12) relative to the inlet port 308.

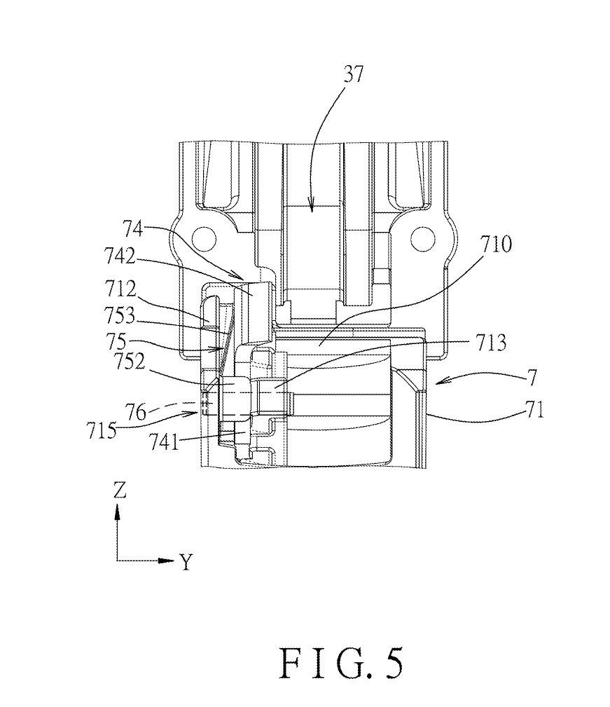

In this embodiment, the press member 71 is in an elongated shape, and as shown in FIGS. 3 and 5, the pressed end segment 715 has a base wall 710, an outer retaining wall 712 extending from the base wall 710 in the first direction (X), and an inner retaining wall 713 extending from the base wall 710 in the first direction (X) to be spaced apart from the outer retaining wall 712 in the second direction (Y). The outer and inner retaining walls 712, 713 are configured to retain a pin member 76 extending in the second direction (Y).

The second biasing member 73 is disposed to bias the pressed end segment 715 to the distal position. In this embodiment, the second biasing member 73 is a helical spring which is sleeved on a pillar 711 formed on an inner surface of the press member 71 (see FIG. 3), and which is disposed between the press member 71 and the lower tubular segment 304.

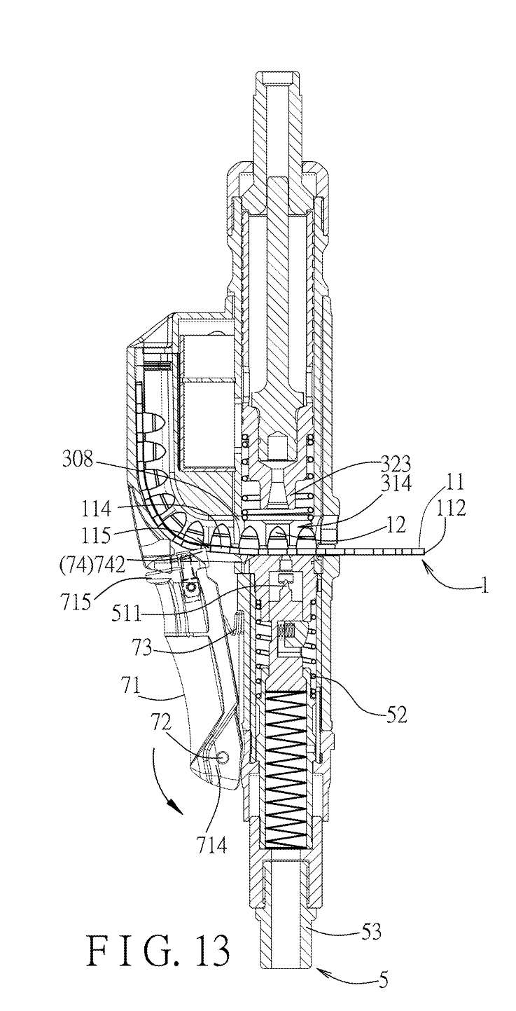

As shown in FIGS. 2 to 5, the claw member 74 includes a base 741 and a claw end 742. The base 741 is elongated, and is mounted to the pressed end segment 715. The claw end 742 extends from the base 741 into the feeding channel 37 to be yieldable in the second direction (Y), and is configured to releasably retain a proximal one of the releasable retained members 115 in the feeding channel 37. When the pressed end segment 715 is displaced from the distal position (FIG. 11) to the proximate position (FIG. 12) against a biasing force of the second biasing member 73, the cartridge strip 1 in the feeding channel 37 is advanced by the claw end 742 to permit a next one of the loaded cartridges 12 (a second one of the loaded cartridges 12 in FIGS. 12 and 13) to be loaded into the firing chamber 314 to the priming position while moving a spent one of the loaded cartridges 12 (a first one of the loaded cartridges 12 in FIGS. 12 and 13) out of the priming position.

In this embodiment, as shown in FIG. 5, the base 741 is retained on the pin member 76, and is disposed between the outer and inner retaining walls 712, 713. The claw end 742 is disposed downstream of the longitudinal zone 371. As shown in FIG. 6, the claw end 742 extends into the transition zone 373.

The leaf spring 75 is disposed to bias the claw end 742 such that the claw end 742 is kept in frictional engagement with the connection strip 11 in the feeding channel 37.

In this embodiment, as shown in FIGS. 2, 3, and 5, the leaf spring 75 is retained on the pin member 76 and is disposed between the outer and inner retaining walls 712, 713 to be in proximity to the outer retaining wall 712. The leaf spring 75 includes a first plate 751, two second plates 752, and a bent plate 753. The first plate 751 is in a square form, and is retained on the pin member 76 to abut against the outer retaining wall 712. The second plates 752 extend respectively from two opposite edges of the first plate 751 to flank the base 741 and to abut against the inner retaining wall 713. The bent plate 753 extends upwardly from the first plate 751 and extends inwardly to abut against the base 741.

Referring back to FIG. 4, it can be found that the firing pin 51 is configured to be slidably disposed within the lower space 305, and extends in the longitudinal direction (Z) to terminate at a firing pin tip 511 and a butt end 512. The firing pin 51 is movable in the longitudinal direction (Z) between a downward position and a firing position. When the firing pin 51 is in the downward position, as shown in FIGS. 4, 6, 12, and 13, the firing pin tip 511 is spaced apart from the firing chamber 314. When the firing pin 51 is in the firing position, as shown in FIG. 11, the firing pin tip 511 moves into the firing chamber 314 so as to ignite the one of the loaded cartridges 12 at the priming position to generate propellant gases to thereby force the piston rod 42 to strike the fastener 10. FIG. 11 merely illustrates a state immediately before occurrence of ignition of the one of the loaded cartridges 12. As soon as the one of the loaded cartridges 12 at the priming position is ignited, the piston 41 is pushed out of the lower bore region 325. It should be noted that only when the piston 41 is pushed out of the lower bore region 325 as result of generation of the propellant gases, is the firing chamber 314 permitted to be in fluid communication with the first through hole 315 through the second through hole 321 thereby allowing the propellant gases to flow out of the barrel bore 324 through the first and second through holes 315, 321.

The actuating unit 5 is disposed in or in proximity to the lower open end 306, and is configured to permit one of the loaded cartridges 12 inside the tubular housing 30 and at the priming position to be ignited in response to axial movement of the actuating unit 5 in the longitudinal direction (Z).

The third biasing member 52 is disposed in the lower space 305 to bias the firing pin 51 to the downward position.

The actuating rod 53 is coupled to the butt end 512 through the lower open end 306, and is configured to force the firing pin 51 to move in the longitudinal direction (Z) toward the firing position against a biasing force of the third biasing member 52.

In this embodiment, as shown in FIG. 10, the powder actuated tool 200 further includes two mounting seats 311 and at least one spring-loaded member 38.

Each of the two mount seats 311 has a cross-section of a circular segment, and is fitted in compliance with a corresponding one of the inner surface regions 310 such that the mounting seats 311 are spaced apart from each other in the second direction (Y) to permit passing of the cartridge strip 1 through the inlet and outlet ports 308, 309. At least one of the mount seats 311 is formed with a recess 316 extending toward a corresponding one of the inner surface regions 310 in the second direction (Y).

The spring-loaded member 38 is disposed in the recess 316 to releasably retain a proximal one of the releasable retained members 115 in the firing chamber 314.

In this embodiment, two of the mounting seats 311 are formed with the recesses 316 which are in line with each other in the second direction (Y), and two of the spring-loaded members 38 are provided in the recesses 316, respectively. Each of the spring-loaded members 38 has a spring 382 received in the corresponding recess 316, and a ball 381 which is biased by the spring 382 to retain the proximal one of the releasable retained members 115 in the firing chamber 314, and which is retracted by a proximal one of the in-between regions 114 into the corresponding recess 316 so as to permit advance of the cartridge strip 1 along the arrow D3. By virtue of the spring-loaded members 38, each of the cartridges 12 can be precisely loaded to the priming position.

In this embodiment, the powder actuated tool 200 further includes a sound suppressor 6 which is disposed between the side frame 35 and the upper tubular segment 301, and which is configured to permit gradual expansion of the propellant gases thereby minimizing the noise. As shown in FIG. 4, the sound suppressor 6 is disposed in an accommodation space 347 defined between the side frame 35 and the upper tubular segment 301.

In this embodiment, as shown in FIGS. 2 to 4, the sound suppressor 6 includes a casing 61 and a partition wall 62. The casing 61, together with the side frame 35 and the upper tubular segment 301, defines an expansion chamber 60 with the gas outlet 355 in proximity to the feed-in port 374 (see FIG. 4). The partition wall 62 has a passing hole 621, and is disposed to partition the expansion chamber 60 into a first sub-chamber 63 and a second sub-chamber 64. The propellant gases, when flows into the first sub-chamber 63, would expand to reduce its flow rate and pressure. Then, the propellant gases, when flows into the second sub-chamber 64, would further expand to further reduce the flow rates and pressure to effectively reduce the noises.

After the first one of the loaded cartridges 12 is ignited, a manual force is exerted to press the pressed end segment 715 from the distal position (FIG. 11) to the proximate position (FIG. 12) along an arrow (F) against the biasing force of the second biasing member 73 to permit the cartridge strip 1 in the feeding channel 37 to be advanced by the claw end 742, while a second one of the loaded cartridges 12 is permitted to be loaded into the firing chamber 314 to the priming position. During advance of the cartridge strip 1, the balls 381 of the spring-loaded members 38 are respectively retracted in the recesses 316. Once the second one of the loaded cartridges 12 is precisely loaded to the priming position, the balls 381 are respectively biased to the springs 382 to retain the connection strip 11.

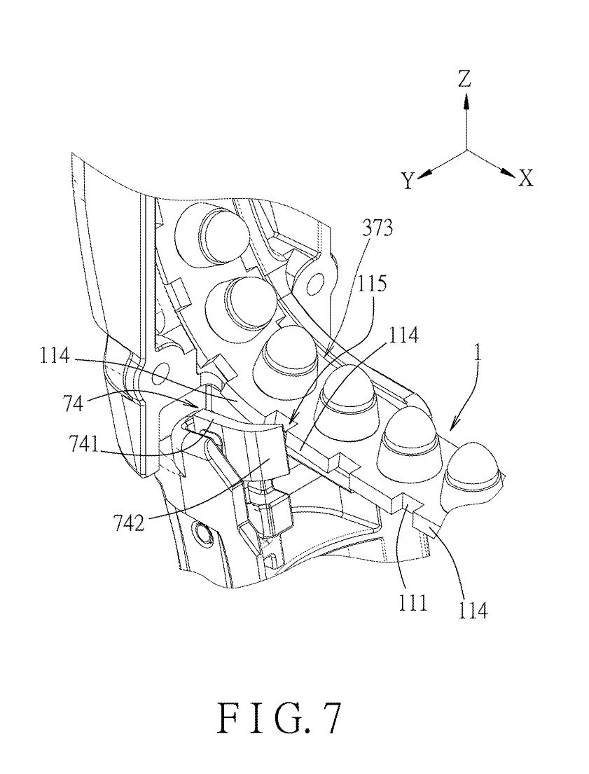

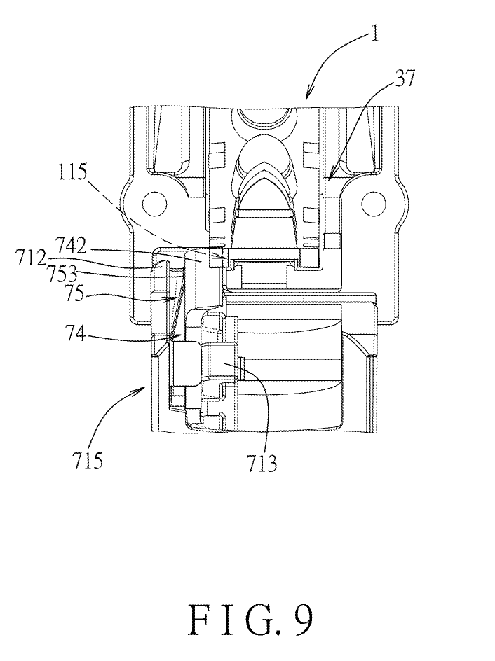

While the manual force is exerted to press the pressed end segment 715 from the distal position (FIG. 11) to the proximate position (FIG. 12), the claw end 742, which is in frictional engagement with one of the releasable retained members 115, and which is in a non-yielded state (FIGS. 7 and 9), is moved angularly with the pressed end segment 715 so as to advance the cartridge strip 1 in the feeding channel 37.

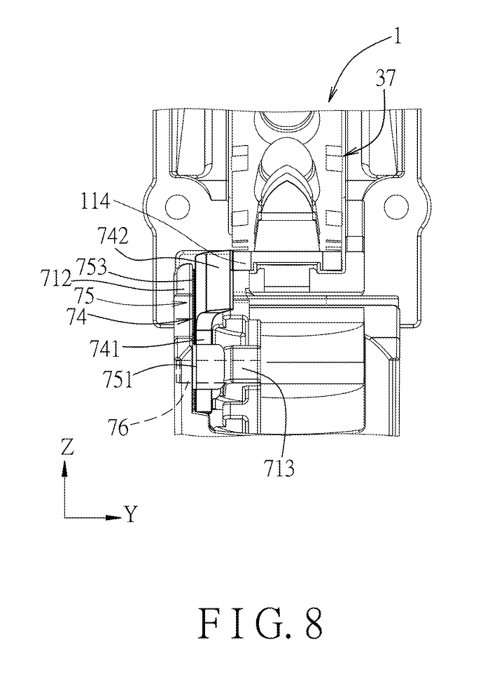

Once the manual force is released, the pressed end segment 715, together with the claw member 74, returns to the distal position (FIG. 13). During return of the claw member 74 with the pressed end segment 715, the claw end 742 is moved angularly with the pressed end segment 715 and is yielded in the second direction (Y) against a biasing force of the leaf spring 75 (see FIG. 8) so as to move over one of the in-between regions 114. Thereafter, once the pressed end segment 715 moves to the distal position, the claw end 742 is disposed to retain a next one of the releasable retained members 115.

Because the feeding channel 37 is of a curved shape, and because the cartridge advancing unit 7 is disposed below the feeding channel 37, the width (W) of the powder actuated tool 200 can be designed to be smaller than the length (L). As such, the powder actuated tool 200 can overcome the problems of the conventional powder actuated tool to access through existing pipes, wires, or decorations for the overhead applications. In addition, the powder actuated tool 200 with the sound suppressor 6 can be operated with reduced noise while maintaining the reduced width of the tool without further adding size of the tool.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A compression triggered powder actuated tool for driving a fastener along a striking path line in a longitudinal direction into a wall surface, said powder actuated tool being adapted for loading therein a cartridge strip which includes a plurality of cartridges displaced from one another along a strip line, and a connection strip that is configured to hold the cartridges, and that extends along the strip line to terminate at a leading end and a trailing end, said powder actuated tool comprising:
a tubular housing which is hollow inside, and which extends along the striking path line to terminate at an upper open end and a lower open end, said tubular housing having an inlet port and an outlet port which is opposite to said inlet port in a first direction transverse to the longitudinal direction to permit passage of the cartridge strip therethrough;
a side frame which is mounted to said tubular housing, and which defines therein a feeding channel for loading therein the cartridge strip, said feeding channel including
a feed-in port proximate to said upper open end,
a longitudinal zone disposed downstream of said feed-in port, and extending in the longitudinal direction,
a transverse zone which is disposed downstream of said longitudinal zone and upstream of said inlet port, and which extends in the first direction, and
a transition zone interconnecting said longitudinal zone and said transverse zone, such that said powder actuated tool has a maximum width in a direction normal to the longitudinal direction which is smaller than a length from a leading edge of a first loading one of the cartridges to the trailing end;
a piston unit which is slidably mounted within said tubular housing, and which is configured to strike the fastener along the striking path line;
a firing pin which is configured to be slidably disposed within said tubular housing, and which is disposed beneath said piston unit, said firing pin being coupled for igniting one of the loaded cartridges inside said tubular housing so as to generate propellant gases to thereby force said piston unit to strike the fastener; and
an actuating unit which is disposed in or in proximity to said lower open end, and which is configured to permit one of the loaded cartridges inside said tubular housing to be ignited in response to axial movement of said actuating unit in the longitudinal direction.

2. The powder actuated tool according to claim 1, further comprising a cartridge advancing unit which includes a claw member with a claw end that extends into said feeding channel for advancing the cartridge strip.

3. The powder actuated tool according to claim 1, further comprising a sound suppressor which is disposed between said side frame and said tubular housing, and which is configured to permit gradual expansion of the propellant gases thereby minimizing the noise.

4. The powder actuated tool according to claim 1, wherein an included angle defined between said longitudinal zone and said transverse zone ranges from 90° to 94°.

5. The powder actuated tool according to claim 3, wherein said sound suppressor includes an expansion chamber with a gas outlet in proximity to said feed-in port, said tubular housing being formed with a first through hole configured such that only when said piston unit is forced to strike the fastener, is the propellant gases permitted to flow through said first through hole into said expansion chamber.

6. The powder actuated tool according to claim 5, wherein said sound suppressor further includes a partition wall which has a passing hole, and which is disposed to partition said expansion chamber into a first sub-chamber and a second sub-chamber.

7. The powder actuated tool according to claim 1, wherein said actuating unit includes an actuating rod which is coupled to said firing pin through said lower open end so as to drive said firing pin to ignite one of the loaded cartridges inside said tubular housing.

8. A compression triggered powder actuated tool for driving a fastener along a striking path line in a longitudinal direction into a wall surface, said powder actuated tool being adapted for loading therein a cartridge strip which includes a plurality of cartridges displaced from one another along a strip line, and a connection strip that is non-stretchable along the strip line, and that is configured to hold the cartridges, the connection strip having a plurality of releasable retained members which alternate with the cartridges, said powder actuated tool comprising:
a tubular housing extending along the striking path line, and including
an upper tubular segment defining therein an upper space, and having an upper open end,
a lower tubular segment defining therein a lower space, and having a lower open end opposite to said upper open end, and
an intermediate tubular segment disposed between said upper and lower tubular segments, and defining therein a firing chamber which interconnects said upper and lower spaces, and which includes an inlet port and an outlet port that are opposite to each other in a first direction transverse to the longitudinal direction to permit passage of the cartridge strip therethrough thereby introducing one of the loaded cartridges in said firing chamber;
a barrel which is fitted slidably in said upper space, and which has an upper coupling end and a lower breech end, said barrel defining therein a barrel bore which extends along the striking path line and which has a lower bore region proximate to said lower breech end, said barrel being movable in the longitudinal direction between a loading position, where said lower breech end is disposed above said firing chamber, and a ready-to-fire position, where said lower breech end is disposed in said firing chamber to receive the one of the loaded cartridges at a priming position;
a first biasing member disposed to bias said barrel to said loading position;
a nosepiece which is coupled to said upper coupling end of said barrel to permit said barrel to move therewith, and which is capable of making a retraction movement when pressed against the wall surface to thereby force said barrel to move to said ready-to-fire position against a biasing force of said first biasing member, said nosepiece having a muzzle bore which is configured to hold the fastener in the striking path line;
a piston which is slidably mounted within said barrel bore, and which is configured to be fitted in said lower bore region to seal said firing chamber when said barrel is in said ready-to-fire position;
a piston rod extending upwardly from said piston along the striking path line into said muzzle bore to terminate at a rod end which is configured to strike the fastener along the striking path line;
a side frame which is mounted to said upper tubular segment, and which defines therein a feeding channel for loading therein the cartridge strip, said feeding channel including
a feed-in port proximate to said upper open end,
a longitudinal zone disposed downstream of said feed-in port, and extending in the longitudinal direction,
a transverse zone which is disposed downstream of said longitudinal zone and upstream of said inlet port, and which extends in the first direction, and
a transition zone interconnecting said longitudinal zone and said transverse zone;
a firing pin configured to be slidably disposed within said lower space, and extending in the longitudinal direction to terminate at a firing pin tip and a butt end, said firing pin being movable in the longitudinal direction between a downward position, where said firing pin tip is spaced apart from said firing chamber, and a firing position, where said firing pin tip moves into said firing chamber so as to ignite the one of the loaded cartridges at the priming position to generate propellant gases to thereby force said piston rod to strike the fastener;
a third biasing member disposed to bias said firing pin to said downward position; and
an actuating rod coupled to said butt end through said lower open end, and configured to force said firing pin to move in the longitudinal direction toward said firing position against a biasing force of said third biasing member.

9. The powder actuated tool according to claim 8, further comprising a cartridge advancing unit which includes a press member having
a pivot end segment which is pivotally mounted relative to said lower tubular segment about a pivot axis in a second direction transverse to both the longitudinal direction and the first direction, and
a pressed end segment which is opposite to said pivot end segment, and which is disposed in proximity to said feeding channel, said pressed end segment being angularly movable about the pivot axis between a distal position and a proximate position relative to said inlet port,
a second biasing member disposed to bias said pressed end segment to said distal position,
a claw member including a base mounted to said pressed end segment, and a claw end which extends from said base into said feeding channel to be yieldable in the second direction, and which is configured to releasably retain a proximal one of the releasable retained members in said feeding channel such that when said pressed end segment is displaced from said distal position to said proximate position against a biasing force of said second biasing member, the cartridge strip in said feeding channel is advanced by said claw end to permit a next one of the loaded cartridges to be loaded into said firing chamber to the priming position while moving a spent one of the loaded cartridges out of the priming position, and
a leaf spring disposed to bias said claw end such that said claw end is kept in frictional engagement with the connection strip in said feeding channel.

10. The powder actuated tool according to claim 9, wherein said claw end is disposed downstream of said longitudinal zone.

11. The powder actuated tool according to claim 8, wherein an included angle defined between said longitudinal zone and said transverse zone ranges from 90° to 94°.

12. The powder actuated tool according to claim 8, wherein said intermediate tubular segment has two inner surface regions opposite to each other in the second direction, said powder actuated tool further comprising:
two mount seats each of which has a cross-section of a circular segment, and each of which is fitted in compliance with a corresponding one of said inner surface regions such that said mounting seats are spaced apart from each other in the second direction to permit passing of the cartridge strip through said inlet and outlet ports, at least one of said mount seats being formed with a recess extending toward a corresponding one of said inner surface regions in the second direction; and
a spring-loaded member which is disposed in said recess to releasably retain a proximal one of the releasable retained members in said firing chamber.

13. The powder actuated tool according to claim 8, wherein said upper tubular segment is formed with a first through hole, and said barrel is formed with a second through hole which is configured such that only when said piston is pushed out of said lower bore region as result of generation of the propellant gases, is said firing chamber permitted to be in fluid communication with said first through hole through said second through hole thereby allowing the propellant gases to flow out of said barrel bore through said first and second through holes, said powder actuated tool further comprising a sound suppressor which is disposed between said side frame and said upper tubular segment, and which is configured to permit rapid expansion of the propellant gases thereby minimizing the noise.

14. The powder actuated tool according to claim 13, wherein said sound suppressor includes an expansion chamber with a gas outlet in proximity to said feed-in port, and a partition wall which has a passing hole, and which is disposed to partition said expansion chamber into a first sub-chamber and a second sub-chamber.

15. The powder actuated tool according to claim 8, further comprising a cap member which is disposed to enclose said upper open end so as to restrict movement of said barrel between said loading position and said ready-to-fire position, and which has a through bore configured to permit passing of said nosepiece.
